(19) United States
(12) Patent Application Publication
(10) Pub. No.: US 2023/0007840 A1
(43) Pub. Date: Jan. 12, 2023

(54) The Use of Semi-Crystalline Polymer Binder for Concentrate Master Batches Containing Vulcanization Accelerators, Sulfur or Carbon Black

(71) Applicant: ExxonMobilel Chemical Patents Inc., Baytown, TX (US)

(72) Inventors: Adrian G. Barry, Houston, TX (US); Paul T.Q. Nguyen, League City, TX (US); Edward J. Blok, Huffman, TX (US); Jianya Cheng, Kingwood, TX (US); Daniella E. Gaona, Portland, TX (US); Christopher E. Hrbacek, Pensacola, FL (US)

(21) Appl. No.: 17/783,005

(22) PCT Filed: Dec. 9, 2020
(86) PCT No.: PCT/US2020/063960

§ 371 Date: Jun. 7, 2022

Related U.S. Application Data
(60) Provisional application No. 62/949,083, filed on Dec. 17, 2019.

(51) Int. Cl. C08J 3/22; C08K 3/06; C08K 5/00

(52) U.S. Cl. CPC C08J 3/226; C08K 3/06; C08K 5/005; C08J 2323/16

(57) ABSTRACT

This invention relates to sulfur, vulcanization accelerator and carbon black master batch formulations comprising either a semi-crystalline propylene-olefin copolymer or a combination of a semi-crystalline propylene-olefin copolymer and a hydrocarbon resin. The semi-crystalline propylene-olefin copolymer or the combination of semi-crystalline propylene-olefin copolymer and hydrocarbon resin imparts a high hardness property to the carbon black, sulfur and accelerator master batch formulations thereby preventing pellet agglomeration during storage and allowing for ease in material handling.

### CROSS-REFERENCE TO RELATED APPLICATIONS

This application claims the priority benefit of U.S. Ser. No. 62/949,083, filed Dec. 17, 2019, which is incorporated herein by reference.

### FIELD OF THE INVENTION

The present invention relates to a sulfur master batch formulation, a vulcanization accelerator master batch formulation and a carbon black master batch formulation for use in elastomeric compositions. The sulfur, vulcanization accelerator and carbon master batch formulations provide a high hardness property, which prevents pellet agglomeration during storage before use and allows for ease in material handling.

### BACKGROUND OF THE INVENTION

Curative master batches containing vulcanization accelerator(s) concentrate or sulfur concentrate in a polymer matrix are commercially available. The polymer matrix or carrier may be EPDM rubber, ethylene-propylene rubber, nitrile rubber or styrene butadiene rubber or a mixture of these rubbers. The main problem with the current curative master batches is the low hardness of the master batch products which results in a high tendency to agglomerate and to have a matte surface. These deficiencies lead to poor storage stability and poor handling capability during production and storage prior to use. These problems can cause major operation and product quality issues for the rubber curing process.

### SUMMARY OF THE INVENTION

Disclosed is a sulfur curative master batch for producing an elastomeric composition. In one embodiment, a sulfur curative master batch composition comprises about 10 to about 30 percent semi-crystalline propylene-olefin copolymer; about 45 to about 60 percent sulfur; and about 10 to about 40 percent vulcanizing accelerator. In a further embodiment, the semi-crystalline propylene-olefin copolymer is an ethylene-propylene copolymer.

In another embodiment, the sulfur curative master batch composition comprises: about 5 to about 30 percent semi-crystalline propylene-olefin copolymer; about 10 to about 20 percent hydrocarbon resin and about 60 to about 80 percent sulfur.

In another embodiment, the sulfur curative master batch composition comprises: about 5 to about 30 percent semi-crystalline propylene-olefin copolymer; about 10 to about 30 percent hydrocarbon resin; about 50 to about 80 percent sulfur; and about 10 to about 80 percent vulcanizing accelerator.

In another embodiment, a vulcanizing accelerator curative master batch composition is disclosed comprising: about 5 to about 30 percent semi-crystalline propylene-olefin copolymer; and about 20 to about 80 percent vulcanizing accelerator. In a further embodiment, the semi-crystalline propylene-olefin copolymer is an ethylene-propylene copolymer. In a another embodiment, the vulcanizing accelerator curative master batch composition further comprises a hydrocarbon resin.

In another embodiment, a carbon black master batch composition is disclosed comprising: about 5 to about 30 percent semi-crystalline propylene-olefin copolymer; about 10 to about 30 percent hydrocarbon resin; about 20 to about 40 percent carbon black and about 5 to about 30 percent antioxidant. In a further embodiment, the semi-crystalline propylene-olefin copolymer is an ethylene-propylene copolymer.

Also disclosed are methods of making the sulfur, vulcanizing accelerator and carbon black master batches of the present invention, wherein the method is either an internal batch mixing process or a continuous twin screw mixing process.

### DETAILED DESCRIPTION OF THE INVENTION

Curative master batches containing vulcanization accelerator(s) concentrate or sulfur concentrate in a polymer matrix are commercially available. The polymer matrix or carrier may be EPDM rubber, ethylene-propylene rubber, nitrile rubber or styrene butadiene rubber or a mixture of these rubbers. The main problem with the current curative master batches is a low hardness of these products with the products having a high tendency to agglomerate and to have a matte surface. This agglomeration and matting of the master batch compounds has resulted in poor storage stability and poor handling capability during production and storage prior to use. These problems can cause major operation and product quality issues for the rubber curing process of elastomeric compositions.

The new concept addresses these problems by using a semi-crystalline propylene-olefin copolymer as a binder for the master batches with significant improvement in product storage and handling stability. A hydrocarbon resin can also added to the semi-crystalline propylene-olefin copolymer to be used as a binder and a process aid to improve hardness, compound viscosity and to facilitate mixing. The use of a semi-crystalline propylene-olefin copolymer or the combination of a semi-crystalline propylene-olefin copolymer and a hydrocarbon resin as a binder works surprisingly well for typical rubber ingredients including a variety of vulcanization accelerators, sulfur and carbon black as well as the various combination of these ingredients. The semi-crystalline propylene-olefin copolymer or the combination of a semi-crystalline propylene-olefin copolymer and a hydrocarbon resin imparts a high hardness property to the carbon black, sulfur and vulcanization accelerator master batch products which prevents pellet agglomeration during storage and promotes ease of material handling.

The sulfur curative, vulcanizing accelerator curative and carbon black master batch formulations of the present invention are useful in making elastomeric compositions. In one embodiment, the elastomeric composition of the present invention comprises the use of a sulfur curative, vulcanizing accelerator curative, carbon black master batch formulation or a combination thereof.

In another embodiment, a tire tread composition comprises the elastomeric composition described herein. In another embodiment, an article comprises the tire tread composition described herein. In another embodiment, a tread for a summer, winter, all-season or truck and bus radial (TBR) tire comprises the tire tread composition described herein.

Sulfur Master Batch

Elastomeric compositions for use in tire tread formulations may use a sulfur curative master batch for ease in use and to improve product quality. The present invention is directed to a sulfur curative master batch for producing elastomeric compositions for use in tire tread formulations. In one embodiment, a sulfur curative master batch composition comprises about 10 to about 30 percent semi-crystalline propylene-olefin copolymer; about 45 to about 60 percent sulfur; and about 10 to about 40 percent vulcanizing accelerator. In a further embodiment, the propylene-olefin copolymer is an ethylene-propylene copolymer.

In a further embodiment, the carrier of the sulfur curative master batch composition is a combination of semi-crystalline propylene-olefin copolymer and hydrocarbon resin. In a further embodiment, the concentration of the hydrocarbon resin in the sulfur curative master batch comprises about 10 to about 20 percent of the sulfur curative master batch.

In a further embodiment, the ratio of semi-crystalline propylene-olefin copolymer to hydrocarbon resin in the sulfur curative master batch ranges from about 1:1 to about 1:4 semi-crystalline propylene-olefin copolymer: hydrocarbon resin. In a further embodiment, the ratio of semi-crystalline propylene-olefin copolymer to hydrocarbon resin ranges from about 1:1 to about 1:3 semi-crystalline propylene-olefin copolymer: hydrocarbon resin.

In a further embodiment, the vulcanizing accelerator of the sulfur curative master batch composition is N-tert-butyl-2-benzothiazole sulphenamide or 2,2′-dithiobisbenzothiazole.

In another embodiment, the sulfur curative master batch composition of the present invention further comprises about 1 to about 30 percent antioxidant. In a further embodiment, the sulfur curative master batch composition comprises about 1 to about 10 percent antioxidant. The sulfur in the sulfur curative master batch composition may be provided either as free sulfur, through a sulfur donor or combinations thereof. Suitable free sulfur includes, for example, pulverized sulfur, precipitated sulfur, colloidal sulfur, rubber maker's sulfur, commercial sulfur, and insoluble sulfur. Each of these may be used of alone or in combination.

In another embodiment, the sulfur curative master batch composition comprises: about 5 to about 30 percent semi-crystalline propylene-olefin copolymer; about 10 to about 20 percent hydrocarbon resin and about 60 to 80 percent sulfur. In a further embodiment, the sulfur curative master batch composition comprises about 1 to about 30 percent antioxidant.

In another embodiment, the sulfur curative master batch composition comprises: about 5 to about 30 percent semi-crystalline propylene-olefin copolymer; about 10 to about 30 percent hydrocarbon resin; about 50 to about 80 percent sulfur; and about 10 to about 80 percent vulcanizing accelerator. In a further embodiment, the sulfur curative master batch composition comprises about 1 to about 30 percent antioxidant.

In another embodiment, the sulfur curative master batch compositions of the present invention are made by either an internal batch mixing process or a continuous twin screw mixing process.

For these inventive sulfur curative master batch compositions, the Shore D hardness as measured by the ASTM 2240 test method is from about 30 to about 70. In a further embodiment, the Shore D hardness is from about 40 to about 70. In a further embodiment, the Shore D hardness is from about 40 to about 60.

Vulcanizing Accelerator Master Batch

Curative packages for elastomeric compositions may also use a vulcanizing accelerator curative master batch for ease in use and to improve product quality. The present invention is also directed to a vulcanizing accelerator curative master batch composition comprising: about 5 to about 30 percent semi-crystalline propylene-olefin copolymer; and about 20 to about 80 percent vulcanizing accelerator. In a further embodiment, the propylene-olefin copolymer is an ethylene-propylene copolymer.

In a further embodiment, the vulcanizing accelerator curative master batch composition further comprises a hydrocarbon resin. In a further embodiment, the concentration of the hydrocarbon resin in the vulcanizing accelerator curative master batch is about 10 to 20 percent.

In a further embodiment, the ratio of semi-crystalline propylene-olefin copolymer to hydrocarbon resin in the vulcanizing accelerator curative master batch ranges from about 1:1 to about 1:4 semi-crystalline propylene-olefin copolymer: hydrocarbon resin. In a further embodiment, the ratio of semi-crystalline propylene-olefin copolymer to hydrocarbon resin ranges from about 1:1 to about 1:3 semi-crystalline propylene-olefin copolymer: hydrocarbon resin.

In another embodiment, the vulcanizing accelerator curative master batch composition comprises about 1 to about 30 percent antioxidant.

Examples of vulcanizing accelerators are sulfenamide-based, guanidine-based, thiuram-based, thiourea-based, benzothiazole-based, dithiocarbamic acid-based, and xanthogenic acid-based compounds, and preferably include 2-mercaptobenzothiazole, dibenzothiazyl disulfide, N-cyclohexyl-2-benzothiazylsulfenamide, N-t-butyl-2-benzothiazolesulfenamide, N-oxyethylene-2-benzothiazolesulfenamide, N-oxyethylene-2-benzothiazolesulfenamide, N,N′-diisopropyl-2-benzothiazolesulfenamide, diphenylguanidine, diorthotolylguanidine, orthotolylbisguanidine, and the like.

Examples of guanidine-based vulcanizing accelerators are diphenylguanidine (DPG), diorthotolylguanidine (DOTG) and orthotolylbisguanidine.

Examples of dithiocarbamic acid-based vulcanizing accelerators are tetramethylthiuram monosulfide (TMTM), tetramethylthiuram disulfide (TMTD) and zinc diethylthiocarbamate (ZDEC).

Examples of sulfenamide-based vulcanizing accelerators are N-cyclohexyl-2-benzothiazylsulfenamide (CBS), N-t-butyl-2-benzothiazolesulfenamide (TBBS), N-oxyethylene-2-benzothiazolesulfenamide, N-oxyethylene-2-benzothiazolesulfenamide, N,N′-diisopropyl-2-benzothiazolesulfenamide, 2-morpholinothiobenzothiazole (MBS) and N-dicyclohexylbenzothiazole-2-sulfenamide (DCBS).

Examples of benzothiazole-based vulcanizing accelerators are 2-mercaptobenzothiazole (MBT), dibenzothiazyl disulfide and 2,2′-dithiobisbenzothiazole (MBTS). MBT and MBTS are also known as delayed-action vulcanizing accelerators.

An example of a vulcanizing accelerator is N-cyclohexyl-2-benzothiazylsulfenamide (CBS) available from Kemai Chemical Co. Another example of a vulcanizing accelerator is diphenyl guanidine available as Ekaland DPG from MLPC International (Arkema).

In another embodiment, the vulcanizing accelerator of the vulcanizing accelerator curative master batch composition is selected from the group consisting of N-tert-butyl-2-benzothiazole sulphenamide, 2,2′-dithiobisbenzothiazole, N-cyclohexyl-2-benzothiazole sulfonamide, 1,3-diphenylguanidine, tetrabenzylthiuram disulfide and a combination thereof. In a further embodiment, the vulcanizing accelerator is 2,2′-dithiobisbenzothiazole (MBTS).

The vulcanizing accelerator may be a single vulcanizing accelerator or a mixture of accelerators. Preferably, the mixture of accelerators is a mixture of different types of accelerators, such as a benzothiazole-based vulcanizing accelerator with a dithiocarbamic acid-based vulcanizing accelerator or a guanidine-based vulcanizing accelerator.

A vulcanizing accelerator may also be combined with a premature vulcanization inhibitor for better control of the vulcanization process. One example of a premature vulcanization inhibitor or a cure retarder is N-(cyclohexylthio)phthalimide (CTP).

In another embodiment, the vulcanizing accelerator curative master batch composition of the present invention is made by either an internal batch mixing process or a continuous twin screw mixing process.

For the vulcanizing accelerator curative master batch composition of the present invention, the Shore D hardness as measured by the ASTM 2240 test method is from about 30 to about 60 or from about 40 to about 70.

Carbon Black Master Batch

The present invention is also directed to a carbon black master batch composition comprising: about 5 to about 30 percent semi-crystalline propylene-olefin copolymer; about 10 to about 30 percent hydrocarbon resin; about 20 to 40 percent carbon black and about 5 to 30 percent antioxidant. In a further embodiment, the carbon black master batch composition comprises about 5 to 20 percent antioxidant.

In a further embodiment, the semi-crystalline propylene-olefin copolymer is an ethylene-propylene copolymer.

In a further embodiment, the ratio of semi-crystalline propylene-olefin copolymer to hydrocarbon resin in the carbon black master batch ranges from about 1:1 to about 1:4 semi-crystalline propylene-olefin copolymer: hydrocarbon resin. In a further embodiment, the ratio of semi-crystalline propylene-olefin copolymer to hydrocarbon resin ranges from about 1:1 to about 1:3 semi-crystalline propylene-olefin copolymer: hydrocarbon resin.

All carbon blacks, in particular blacks of the HAF, ISAF or SAF type, conventionally used in tires (“tire-grade” blacks) are suitable as carbon blacks. Some examples are reinforcing carbon blacks of the 100, 200 or 300 series (ASTM grades), such as, for example, the N115, N134, N234, N326, N330, N339, N347 or N375 blacks, or also, depending on the applications targeted, the blacks of higher series (for example, N660, N683 or N772). An example of a carbon black is Vulcan®3 N330 from Cabot Corp. or Vulcan 7H N234 from Cabot Corp.

In another embodiment, the carbon black master batch composition of the present invention is made by either an internal batch mixing process or a continuous twin screw mixing process.

For the carbon black master batch composition of the present invention, the Shore D hardness is from about 30 to about 70. In a further embodiment, the Shore D hardness of the carbon black master batch composition is from about 40 to about 70. In a further embodiment, the Shore D hardness of the carbon black master batch composition is from about 50 to about 70.

Propylene-Olefin Copolymer

The “propylene-olefin copolymer” as used herein may be any polymer comprising propylene and other olefin comonomers. As used herein, a copolymer may refer to a polymer comprising at least two monomers, optionally with other monomers.

An example of an amorphous ethylene-propylene copolymer is Vistalon™ available from ExxonMobil Chemical Company. Vistalon™ 404 is an ethylene propylene copolymer rubber with 45 wt % ethylene content available from ExxonMobil Chemical. Amorphous ethylene-propylene copolymer with a dispersing agent is also available as Rhenogran TBBS-80 from LANXESS.

Partially or semi-crystalline propylene-olefin copolymers are described in, for example, U.S. Pat. No. 8,013,093. In one embodiment, the semi-crystalline propylene-olefin copolymer is ethylene-propylene copolymer. Semi-crystalline ethylene-propylene copolymer is commercially available as Vistamaxx™ available from ExxonMobil Chemical Company. Vistamaxx™ 3000 is a copolymer of isotactic propylene with random ethylene distribution from ExxonMobil Chemical Company.

In one embodiment of the present invention, the master batch formulations of the present invention comprise a semi-crystalline propylene-olefin copolymer or a combination of a semi-crystalline propylene-olefin copolymer and amorphous propylene-olefin copolymer.

The crystallinity of the propylene-olefin copolymer may be expressed in terms of percentage of crystallinity (i.e., % crystallinity), as determined according to the DSC procedure described herein. The semi-crystalline propylene-olefin copolymer has a % crystallinity of from 5% to 45%. As used herein, the term “semi-crystalline propylene-olefin copolymer” means that the copolymers have a range of crystallinity of 5 to 45 percent as measured using Differential Scanning calorimetry (DSC). Preferably, the range of crystallinity is about 10 to about 40 percent. Commerically available examples of semi-crystalline ethylene-propylene copolymer are Vistamaxx™ 3000 and 3980 FL (ExxonMobil Chemical Company). Other Vistamaxx™ polymers with lower percentages of crystallinity are Vistamaxx™ 6502 and 6202.

The Differential Scanning calorimetry (DSC) procedure may be used to determine heat of fusion and melting temperature of the propylene-olefin copolymer. The method is as follows: approximately 6 mg of material placed in microliter aluminum sample pan. The sample is placed in a Differential Scanning calorimeter (Perkin Elmer Pyris 1 Thermal Analysis System) and is cooled to −80° C. The sample is heated at 10° C./min to attain a final temperature of 120° C. The sample is cycled twice. The thermal output, recorded as the area under the melting peak of the sample, is a measure of the heat of fusion and may be expressed in Joules per gram of polymer and is automatically calculated by the Perkin Elmer System. The melting point is recorded as the temperature of the greatest heat absorption within the range of melting of the sample relative to a baseline measurement for the increasing heat capacity of the polymer as a function of temperature.

The term propylene-olefin copolymer also encompasses “ethylene-propylene-diene terpolymer.” The term “terpolymer” as used herein refers to a polymer synthesized from three different monomers.

Terpolymers, in some embodiments, may be produced (1) by mixing all three monomers at the same time or (2) by sequential introduction of the different comonomers. The mixing of comonomers may be done in one, two, or possible three different reactors in series and/or in parallel. Preferably the ethylene-propylene-diene terpolymer comprises (i) propylene-derived units, (ii) α-olefin-derived units and (iii) diene-derived units. The ethylene-propylene-diene terpolymer may be prepared by polymerizing (i) propylene with (ii) at least one of ethylene and C₄-C₂₀ α-olefins and (iii) one or more dienes.

The comonomers may be linear or branched. Preferred linear comonomers include ethylene or C₄ to C₈ α-olefins, more preferably ethylene, 1-butene, 1-hexene, and 1-octene, even more preferably ethylene or 1-butene. Preferred branched comonomers include 4-methyl-1-pentene, 3-methyl-1-pentene, and 3,5,5-trimethyl-1-hexene. In one or more embodiments, the comonomers may include styrene.

The dienes may be conjugated or non-conjugated. Preferably, the dienes are non-conjugated. Illustrative dienes may include, but are not limited to, 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1, 4-cyclohexadiene; vinyl norbornene (VNB); dicyclopendadiene (DCPD); and combinations thereof. Preferably, the diene is ENB or VNB. Preferably, the ethylene-propylene-diene terpolymer comprises an ENB content of from 0.5 wt % to 8 wt % based on the weight of the terpolymer, or from 2 wt % to 6 wt %, or from 3 wt % to 5 wt %. More preferably, the ethylene-propylene-diene terpolymer comprises an ENB content of from 0.5 wt % to 3 wt %.

The ethylene-propylene-diene terpolymer may have a propylene amount of from 65 wt % to 95 wt %, or from 70 wt % to 95 wt %, or from 75 wt % to 95 wt %, or from 80 wt % to 95 wt %, or from 83 wt % to 95 wt %, or from 84 wt % to 95 wt %, or from 84 wt % to 94 wt %, or from 72 wt % to 95 wt %, or from 80 wt % to 93 wt %, or from 85 wt % to 89 wt %, based on the weight of the polymer. The balance of the ethylene-propylene-diene terpolymer comprises at least one of ethylene and C₄-C₂₀ α-olefin and one or more dienes. The α-olefin may be ethylene, butene, hexane, or octene. When two or more α-olefins are present in the polymer, ethylene and at least one of butene, hexane, or octene are preferred.

Preferably, the ethylene-propylene-diene terpolymer comprises from 2 to 30 wt % of C₂ and/or C₄-C₂₀ α-olefins based the weight of the ethylene-propylene-diene terpolymer. When two or more of ethylene and C₄-C₂₀ α-olefins are present the combined amounts of these olefins in the polymer is preferably at least 2 wt % and falling within the ranges described herein. Other preferred ranges of the amount of ethylene and/or one or more α-olefins include from 2 wt % to 15 wt %, or from 5 wt % to 15 wt %, or from 8 wt % to 15 wt %, or from 8 to 12 wt %, based on the weight of the ethylene-propylene-diene terpolymer.

Preferably, the ethylene-propylene-diene terpolymer comprises an ethylene content of from 5 wt % to 25 wt % based on the weight of the terpolymer, or from 8 wt % to 12 wt %.

Preferably, the ethylene-propylene-diene terpolymer comprises a diene content of from 1 wt % to 16 wt % based on the weight of the terpolymer, or from 1 wt % to 12 wt %, or 2 wt % to 6 wt %, or from 2 wt % to 6 wt %.

In one embodiment, the synthesis of the ethylene-propylene-diene terpolymer utilizes a bis((4-triethylsilyl)phenyl)methylene(cyclopentadienyl) (2,7-di-tert-butyl-fluoren-9-yl) hafnium dimethyl catalyst precursor. However, other metallocene precursors with good diene incorporation and MW capabilities could also be used. The synthesis of the ethylene-propylene-diene terpolymer also utilizes a dimethylanilinium tetrakis(pentafluorophenyl)borate activator but dimethylanilinium-tetrakis(heptafluoronaphthyl)borate and other non-coordinating anion type activators or MAO could also be used.

In a reactor, a copolymer material is produced in the presence of ethylene, propylene, ethylidene norbornene, and a catalyst comprising the reaction product of N,N-dimethylanilinium tetrakis(pentafluorophenyl)borate and [cyclopentadienyl(2,7-di-t-butylfluorenyl)di-p-triethylsilanephenylmethane] hafnium dimethyl. The copolymer solution emerging from the reactor is quenched and then devolatilized using conventionally known devolatilization methods, such as flashing or liquid phase separation, first by removing the bulk of the isohexane to provide a concentrated solution, and then by stripping the remainder of the solvent in anhydrous conditions using a devolatilizer so as to end up with a molten polymer composition containing less than 0.5 wt % of solvent and other volatiles. The molten polymer composition was advanced by a screw to a pelletizer from which the ethylene-propylen-diene terpolymer composition pellets are submerged in water and cooled until solid.

The semi-crystalline ethylene-propylene-diene terpolymer may have a heat of fusion (H_{f}) determined by the DSC procedure described herein, which is greater than or equal to 60 Joules per gram (J/g), equal to or greater than 70 J/g, or equal to or greater than 80 J/g.

The ethylene-propylene-diene terpolymer may be a blend of discrete random ethylene-propylene-diene terpolymers as long as the polymer blend has the properties of the semi-crystalline ethylene-propylene-diene terpolymer as described herein. The number of ethylene-propylene-diene terpolymers may be three or less, or two or less. In one or more embodiments, the ethylene-propylene-diene terpolymer may include a blend of two ethylene-propylene-diene terpolymers differing in the olefin content, the diene content, or the both.

Carbon Black

All carbon blacks, in particular blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or also, depending on the applications targeted, the blacks of higher series (for example, N660, N683 or N772).

An example of a carbon black is Vulcan®3 N330 from Cabot Corp. or Vulcan 7H N234 from Cabot Corp.

Hydrocarbon Resin

Hydrocarbon resins are formed of C₅ fraction/vinylaromatic copolymer, in particular of C₅ fraction/styrene or C₅ fraction/C₉ fraction copolymer and are known as processing aid in tire rubber compositions.

Suitable hydrocarbon resins include, but are not limited to aliphatic hydrocarbon resins, hydrogenated aliphatic hydrocarbon resins, aromatic hydrocarbon resins, hydrogenated aromatic hydrocarbon resins, aliphatic/aromatic hydrocarbon resins, hydrogenated aliphatic/aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, coumarone indene resins, polyterpene resins, modified terpene resins, terpene-phenol resins, rosins, rosin esters, resins grafted with an unsaturated acid or anhydride, and mixtures of any two or more thereof.

The hydrocarbon resin is a C₆ aliphatic hydrocarbon resins such as ESCOREZ™ 1102, ESCOREZ™ 1310 available from ExxonMobil Chemical Company, Houston, Tex., WINGTACK™ 10, 95 and 98 available from Cray Valley Total, and QUINTONE™ K100, R100, and A100 available from Nippon Zeon of Japan.

Examples of low molecular weight hydrogenated aliphatic resin are Regalite T1140 (Hercules, Inc.) and Escorez 5340 and 5320 (ExxonMobil Chemical).

Suitable mixed C₅/C₉ resins include Oppera™ PR373, and ESCOREZ™ 2203 LC available from ExxonMobil Chemical Company, Houston, Tex., PICCOTAC™ 8095 available from Eastman, WINGTACK™ ET available from Cray Valley, and QUINTONE™ D100, N180, P195N, and U190 available from Nippon Zeon.

Suitable hydrogenated mixed C₅/C₉ resins include REGALITE™ R1090, and R1125 available from Eastman.

Preferred examples of hydrocarbon resins are Oppera™ PR373 from ExxonMobil Chemical Co, and Escorez™ E5300 and E5320 from ExxonMobil Chemical Co.

In one embodiment, the master batch compositions of the present invention further comprise about 5 to about 30 percent hydrocarbon resin. In another embodiment, the master batch composition of the present invention comprises about 10 to about 30 percent hydrocarbon resin. In another embodiment, the master batch composition of the present invention comprises about 10 to about 20 percent hydrocarbon resin.

In another embodiment, the ratio of semi-crystalline propylene-olefin copolymer to hydrocarbon resin in the master batch formulations of the present invention ranges from about 1:1 to about 1:4 semi-crystalline propylene-olefin copolymer: hydrocarbon resin. In a further embodiment, the ratio of semi-crystalline propylene-olefin copolymer to hydrocarbon resin in the master batch formulations ranges from about 1:1 to about 1:3 semi-crystalline propylene-olefin copolymer: hydrocarbon resin.

In a further embodiment, the master batch composition of the present invention is either a sulfur, a vulcanizing accelerator or a carbon black master batch.

Antidegradants

In one embodiment, an antidegradant or stabilizer may be added to the master batch for product shelf life stability. In one embodiment, the stabilizer is an antioxidant.

Antidegradants encompass antioxidants, antiozonants and waxes. Antiozonanats are used to protect rubber products from ozone. Waxes are also used to provided rubber ozone protection. An example of an antiozone wax is AKROWAX™ 5084 from AkroChem.

As used herein, the term “antioxidant” refers to a chemical that combats oxidative degradation. Suitable antioxidants include diphenyl-p-phenylenediamine and those disclosed in The Vanderbilt Rubber Handbook (1978), Pages 344 to 346. A particularly preferred antioxidant is para-phenylenediamines, which is commercially available by Eastman under the trade name SANTOFLEX™ 6PPD (N-(1,3-Dimethylbutyl)-N′-phenyl-1,4-phenylenediamine) Another preferred antioxidant is a high-molecular-weight, hindered amine light stabilizer, which is commercially available as CHIMASSORB® 2020 from BASF Corp. In another embodiment, the antioxidant is AGERITE™ RESIN D (polymerized 1,2-dihydro-2,24-trimethylquinoline) available from R. T. Vanderbilt.

In one embodiment, the master batch compositions of the present invention further comprise about 1 to about 30 percent antioxidant. In a further embodiment, the master batch compositions further comprise about 5 to about 30 percent antioxidant. In a further embodiment, the master batch compositions further comprise about 10 to about 30 percent antioxidant. In a further embodiment, the master batch compositions further comprise about 15 to about 30 percent antioxidant. In a further embodiment, the master batch compositions further comprise about 5 to about 20 percent antioxidant. In a further embodiment, the master batch compositions further comprise about 10 to about 20 percent antioxidant.

Cure Packages

The elastomeric compositions and the articles made from those elastomeric compositions are generally manufactured with the aid of at least one cure package, at least one curative, at least one vulcanizing or crosslinking agent, and/or undergo a process to cure the elastomeric composition. The present invention discloses curative master batch formulations comprising a curative package. As used herein, at least one curative package refers to any material or method capable of imparting cured properties to a rubber as is commonly understood in the industry. A preferred crosslinking agent is sulfur.

The sulfur may be provided either as free sulfur, through a sulfur donor or combinations thereof. Suitable free sulfur includes, for example, pulverized sulfur, precipitated sulfur, colloidal sulfur, rubber maker's sulfur, commercial sulfur, and insoluble sulfur. Each of these may be used of alone or in combination.

Examples of vulcanizing accelerators are sulfenamide-based, guanidine-based, thiuram-based, thiourea-based, benzothiazole-based, dithiocarbamic acid-based, and xanthogenic acid-based compounds, and preferably include 2-mercaptobenzothiazole, dibenzothiazyl disulfide, N-cyclohexyl-2-benzothiazylsulfenamide, N-t-butyl-2-benzothiazolesulfenamide, N-oxyethylene-2-benzothiazolesulfenamide, N-oxyethylene-2-benzothiazolesulfenamide, N,N′-diisopropyl-2-benzothiazolesulfenamide, diphenylguanidine, diorthotolylguanidine, orthotolylbisguanidine, and the like.

Examples of guanidine-based vulcanizing accelerators are diphenylguanidine (DPG), diorthotolylguanidine (DOTG) and orthotolylbisguanidine.

Examples of dithiocarbamic acid-based vulcanizing accelerators are tetramethylthiuram monosulfide (TMTM), tetramethylthiuram disulfide (TMTD), zinc diethylthiocarbamate (ZDEC) and tetrabenzylthiuram disulfide (TBZTD).

Examples of sulfenamide-based vulcanizing accelerators are N-cyclohexyl-2-benzothiazylsulfenamide (CBS), N-tert-butyl-2-benzothiazolesulfenamide (TBBS), N-oxyethylene-2-benzothiazolesulfenamide, N-oxyethylene-2-benzothiazolesulfenamide, N,N′-diisopropyl-2-benzothiazolesulfenamide, 2-morpholinothiobenzothiazole (MBS) and N-dicyclohexylbenzothiazole-2-sulfenamide (DCBS).

Examples of benzothiazole-based vulcanizing accelerators are 2-mercaptobenzothiazole (MBT), dibenzothiazyl disulfide and 2,2′-dithiobisbenzothiazole (MBTS). MBT and MBTS are also known as delayed-action vulcanizing accelerators.

An example of a vulcanizing accelerator is N-cyclohexyl-2-benzothiazylsulfenamide (CBS) available from Kemai Chemical Co. Another example of a vulcanizing accelerator is diphenyl guanidine (DPG) available as Ekaland DPG from MLPC International (Arkema).

Preferably the vulcanizing accelerator is N-tert-butyl-2-benzothiazole sulphenamide, 2,2′-dithiobisbenzothiazole, N-cyclohexyl-2-benzothiazole sulfonamide, 1,3-diphenylguanidine, tetrabenzylthiuram disulfide or a combination thereof.

The vulcanizing accelerator may be a single vulcanizing accelerator or a mixture of accelerators. Preferably, the mixture of accelerators is a mixture of different types of accelerators, such as a benzothiazole-based vulcanizing accelerator with a dithiocarbamic acid-based vulcanizing accelerator or a guanidine-based vulcanizing accelerator.

A vulcanizing accelerator may also be combined with a premature vulcanization inhibitor for better control of the vulcanization process. One example of a premature vulcanization inhibitor or a cure retarder is N-(cyclohexylthio)phthalimide (CTP).

In one embodiment, the sulfur curative master batch or the vulcanizing accelerator master batch formulation is made by either the internal batch or continuous twin screw mixing process described herein.

Preferably, the sulfur curative master batch formulation or the vulcanizing accelerator curative master batch formulation of the present invention is used in the preparation of elastomeric compositions.

The various descriptive elements and numerical ranges disclosed herein, the reactants used to make the master batch formulations as disclosed herein, and their use in the preparation elastomeric compositions can be combined with other descriptive elements and numerical ranges to describe the invention(s); further, for a given element, any upper numerical limit can be combined with any lower numerical limit described herein. The features of the invention are described in the following non-limiting examples.

### EXAMPLES

Internal Batch Mixing Process:

The following master batch formulations were made using an internal batch mixing process as follows: The compounds were mixed in suitable internal mixers, using one pass or multiple successive passes well known to the person skilled in the art. All components were listed in %. The mixing temperatures ranged between 65° C. and 150° C. The duration of the mixing for each of the individual mixing step was between 1 and 30 minutes or until the mixing torque was stabilized. The final mix was removed from the mixer and cooled to room temperature either by pressing between Teflon sheets or by an underwater pelletizer process.

The following examples illustrated the improvement in hardness of the master batches produced with a semi-crystalline propylene-ethylene copolymer binder or carrier with and without the use of hydrocarbon tackifier resin as part of the binder when comparing to a commercial product based on an amorphous EPDM binder.

### Examples 1-9: Combined Sulfur Curative Master Batch Formulations with Accelerator Made with the Internal Batch Mixing Process

Examples 1, 3 and 5 were control sulfur master batch formulations using a commercial product (Vistalon™ 404) based on an EPDM binder. Examples 2, 4, 6, 7, 8 and 9 were sulfur master batch formulations comprising a semi-crystalline propylene-ethylene copolymer. Examples 7 and 8 comprised a semi-crystalline propylene-ethylene copolymer with EPDM as a carrier. Example 9 comprised a semi-crystalline propylene-ethylene copolymer with a hydrocarbon resin as a carrier.

Examples 2, 4, 6, 7, 8 and 9 comprised a semi-crystalline propylene-ethylene copolymer, a vulcanization accelerator and sulfur. Example 5 comprised a semi-crystalline propylene-ethylene copolymer, a combination of vulcanization accelerators, an antioxidant and sulfur. Example 6 comprised a semi-crystalline propylene-ethylene copolymer, a vulcanization accelerator, an antioxidant and sulfur. Examples 7 and 8 comprised a semi-crystalline propylene-ethylene copolymer with EPDM as a carrier, a vulcanization accelerator, an antioxidant and sulfur. Example 9 comprised a semi-crystalline propylene-ethylene copolymer with a hydrocarbon resin as a carrier, a vulcanization accelerator, a cure retarder and sulfur.

| Ingredient | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Vistaion ™ | 15 | | 15.7 | | 20.0 | | 4.3 | 2.1 | |
| 404 (1) | | | | | | | | | |
| Vistamaxx ™ | | 15 | | 15.7 | | 20.0 | 15.7 | 17.9 | 12.5 |
| 3000 (2) | | | | | | | | | |
| Escorez 5320 (3) | | | | | | | | | 12.5 |
| TBBS (4) | 32 | 32 | 10.5 | 10.5 | 10.5 | 10.5 | 10.5 | 10.5 | 25.1 |
| MBTS (5) | | | 4 | 4 | | | | | |
| CTP retarder (6) | | | | | | | | | 3 |
| CHIMASSORB | | | 17 | 17 | 17 | 17 | 17 | 17 | |
| 2020 (7) | | | | | | | | | |
| Sulfur | 53 | 53 | 53 | 53 | 53 | 53 | 53 | 53 | 46.9 |
| TOTAL (%) | 100 | 100 | 100 | 100 | 100 | 100 | 100 | 100 | 100 |
| Shore D | 17.5 | 51.5 | 22.4 | 47.2 | 17.9 | 41.7 | 40.9 | 46.4 | 53.6 |
| (ASTM 2240) | | | | | | | | | |
| Shore D | | 2.9× | | 2.1× | | 2.3× | 2.3× | 2.6× | |
| Comparison | | | | | | | | | |
| to Control | | | | | | | | | |

(1) Ethylene propylene copolymer rubber, 45 wt % ethylene content from ExxonMobil Chemical
(2) Copolymer of Isotactic propylene with random ethylene distribution from ExxonMobil Chemical
(3) Hydrocarbon tackifier resins from ExxonMobil
(4) N-tert-butyl-benzothiazole sulfonamide
(5) Benzothiazole disulfide
(6) N-(cyclohexylthio) Phthalimide
(7) High-molecular-weight, hindered amine light stabilizer from BASF Corp.

Examples 1 to 9 were measured for hardness using the method of ASTM 2240. Sulfur Master Batch Examples 2, 4, 6, 7, 8 and 9 exhibited increased hardness (2.1× to 2.9×) in comparison to their control formulation which did not contain a semi-crystalline propylene-ethylene copolymer.

Example 2 was a Sulfur Master Batch formulation comprising a semi-crystalline propylene-ethylene copolymer, a vulcanization accelerator and sulfur. In comparison with its control formulation (Example 1) comprising amorphous EPDM, Example 2 exhibited 2.9 times greater Shore D hardness.

Example 4 was a Sulfur Master Batch formulation comprising a semi-crystalline propylene-ethylene copolymer, a combination of vulcanization accelerators, an antioxidant and sulfur. In comparison with its control formulation (Example 3) comprising amorphous EPDM,

Example 4 exhibited 2.1 times greater Shore D hardness.

Example 6 was a sulfur master batch formulation comprising a semi-crystalline propylene-ethylene copolymer, a vulcanization accelerator, an antioxidant and sulfur. In comparison with its control formulation (Example 5) comprising amorphous EPDM, Example 6 exhibited 2.3 times greater Shore D hardness. Examples 7 and 8 were sulfur master batch formulation comprising a semi-crystalline propylene-ethylene copolymer and EPDM as a carrier, a vulcanization accelerator, an antioxidant and sulfur. In comparison with their control formulation (Example 5), Examples 7 and 8 exhibited 2.3 to 2.6 times greater Shore D hardness.

With respect to Example 9, as compared to the Shore D hardness of Example 2 (Shore D 51.5), the addition of the hydrocarbon resin to the semi-crystalline propylene-ethylene copolymer carrier exhibited an increased Shore D hardness of 53.6.

### Examples 10-18: Vulcanization Accelerator Master Batch Formulations without Hydrocarbon Resin Made with the Internal Batch Mixing Process

Example 10 is the control vulcanization accelerator master batch formulation using a commercial product (Vistalon™ 404) based on an amorphous EPDM binder. Examples 11 to 18 are accelerator master batch formulations comprising a semi-crystalline propylene-ethylene copolymer. Examples 11, 12, 13, 17 and 18 comprise a semi-crystalline propylene-ethylene copolymer with a vulcanizing accelerator. Examples 14, 15 and 16 comprise a semi-crystalline propylene-ethylene copolymer with a combination of vulcanizing accelerators.

| Ingredient | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|
| Vistaion ™ | 25 | | | | | | | | |
| 404 (1) | | | | | | | | | |
| Vistamaxx ™ | | 25 | 25.0 | 25.0 | 25.0 | 25.0 | 25.0 | 25.0 | 25.0 |
| 3000 (2) | | | | | | | | | |
| TBBS (3) | 75 | 75 | | | | | | | |
| MBTS (4) | | | | | | | | 75 | |
| CBS (5) | | | 75 | | 37.5 | 22.5 | 52.5 | | |
| DPG (6) | | | | 75 | 37.5 | 52.5 | 22.5 | | |
| TBZTD (7) | | | | | | | | | 75 |
| TOTAL (%) | 100 | 100 | 100 | 100 | 100 | 100 | 100 | 100 | 100 |
| Shore D | 15.1 | 50.9 | 41.5 | 41.5 | 42.5 | 40.8 | 42.8 | 53.0 | 30.1 |
| (ASTM 2240) | | | | | | | | | |
| Shore D | | 3.4× | 2.7× | 2.7× | 2.7× | 2.7× | 2.8× | 3.5× | 2.0× |
| Comparison | | | | | | | | | |
| to Control | | | | | | | | | |

(1) Ethylene propylene copolymer rubber, 45 wt % ethylene content from ExxonMobil Chemical
(2) Copolymer of Isotactic propylene with random ethylene distribution from ExxonMobil Chemical
(3) N-tert-butyl-benzothiazole sulfonamide
(4) Benzothiazole disulfide
(5) N-cyclohexyl-2-benzothiazole sulfonamide
(6) 1,3-Diphenylguanidine
(7) Tetrabenzyl thiuram disulfide

Examples 10-18 were measured for hardness using the method of ASTM 2240. Examples 11-18 comprise a semi-crystalline propylene-ethylene copolymer. Vulcanization accelerator Master Batch Examples 11-18 exhibited increased hardness (2.0× to 3.4×) in comparison to their control formulation which did not contain a semi-crystalline propylene-ethylene copolymer.

Example 11 was a vulcanizing accelerator master batch formulation comprising a semi-crystalline propylene-ethylene copolymer and a vulcanization accelerator (TBBS). In comparison with its control formulation (Example 10) comprising amorphous EPDM, Example 11 exhibited 3.4 times greater Shore D hardness.

Examples 12, 13, 14, 15 and 16 were vulcanizing accelerator master batch formulations comprising a semi-crystalline propylene-ethylene copolymer and a vulcanization accelerator or a combination of vulcanization accelerators. In comparison with its control formulation (Example 10) comprising amorphous EPDM, Examples 12 to 16 exhibited 2.7 to 2.8 times greater Shore D hardness.

Example 17 was a vulcanizing accelerator master batch formulation comprising a semi-crystalline propylene-ethylene copolymer and a vulcanization accelerator (MBTS). In comparison with its control formulation (Example 10) comprising amorphous EPDM, Example 17 exhibited 3.5 times greater Shore D hardness. The combination of a semi-crystalline propylene-ethylene copolymer and the vulcanization accelerator, TBBS or MBTS, exhibited the highest increase Shore D hardness (3.4 to 3.5 greater) in comparison to its control formulation.

### Examples 19-30: Vulcanization Accelerator Master Batch Formulations with Hydrocarbon Resin Made with the Internal Batch Mixing Process

Example 19 is the control accelerator master batch formulation using a commercial product (Vistalon™ 404) based on an EPDM binder. Examples 20, 21, 22, 23, 24, 28 and 29 were accelerator master batch formulations comprising a semi-crystalline propylene-ethylene copolymer, an accelerator and a hydrocarbon resin. Examples 25, 26 and 27 were accelerator master batch formulations comprising a semi-crystalline propylene-ethylene copolymer, a combination of accelerators and a hydrocarbon resin. Example 30 is an accelerator master batch formulation comprising a semi-crystalline propylene-ethylene copolymer, an accelerator, an antioxidant and a hydrocarbon resin.

| Ingredient | Ex. 19 | Ex. 20 | Ex. 21 | Ex. 22 | Ex. 23 | Ex. 24 | Ex. 25 | Ex. 26 | Ex. 27 | Ex. 28 | Ex. 29 | Ex. 30 |
|---|---|---|---|---|---|---|---|---|---|---|---|---|
| Vistaion ™ | 12.5 | | | | | | | | | | | |
| 404 (1) | | | | | | | | | | | | |
| Vistamaxx ™ | | 12.5 | 6.25 | 6.25 | 12.5 | 12.5 | 12.5 | 12.5 | 12.5 | 12.5 | 12.5 | 6.3 |
| 3000 (2) | | | | | | | | | | | | |
| TBBS (3) | 75 | 75 | 75.0 | 75.0 | | | | | | | | |
| MBTS (4) | | | | | | | | | | 75 | | |
| CBS (5) | | | | | 75 | | 37.5 | 22.5 | 52.5 | | | |
| DPG (6) | | | | | | 75 | 37.5 | 52.5 | 22.5 | | | |
| TBZTD (7) | | | | | | | | | | | 75 | 49 |
| Chimassorb | | | | | | | | | | | | 26 |
| 2020 (8) | | | | | | | | | | | | |
| Escorez | 12.5 | | | 18.75 | 12.5 | 12.5 | 12.5 | 12.5 | 12.5 | 12.5 | 12.5 | 18.75 |
| 5300 (9) | | | | | | | | | | | | |
| Escorez | | 12.5 | 18.75 | | | | | | | | | |
| 5320 (10) | | | | | | | | | | | | |
| TOTAL (%) | 100 | 100 | 100 | 100 | 100 | 100 | 100 | 100 | 100 | 100 | 100 | 100 |
| SHORE D | 19.7 | 51.3 | 65 | 63.8 | 56.7 | 46.3 | 54.6 | 50.2 | 49.4 | 56.7 | 45.1 | 59.4 |
| (ASTM 2240) | | | | | | | | | | | | |
| Shore D | | 2.6× | 3.3× | 3.2× | 2.9× | 2.4× | 2.8× | 2.5× | 2.5× | 2.9× | 2.3× | 3× |
| Comparison | | | | | | | | | | | | |
| to Control | | | | | | | | | | | | |

(1) Ethylene propylene copolymer rubber, 45 wt % ethylene content from ExxonMobil Chemical
(2) Copolymer of Isotactic propylene with random ethylene distribution from ExxonMobil Chemical
(3) N-tert-butyl-benzothiazole sulfonamide
(4) Benzothiazole disulfide
(5) N-cyclohexyl-2-benzothiazole sulfonamide
(6) 1,3-Diphenylguanidine
(7) Tetrabenzyl thiuram disulide
(8) High-molecular-weight, hindered amine light stabilizer from BASF Corp.
(9) & (10) Hydrocarbon tackifier resins from ExxonMobil

Examples 19 to 30 were measured for hardness using the method of ASTM 2240. Examples 20-29 comprised a semi-crystalline propylene-ethylene copolymer and a hydrocarbon resin as a carrier and a vulcanizing accelerator or combination of vulcanizing accelerators. Example 30 comprised a semi-crystalline propylene-ethylene copolymer and a hydrocarbon resin as a carrier, a vulcanizing accelerator and an antioxidant. Accelerator Master Batch Examples 20-30 exhibited increased hardness (2.3 to 3.3×) in comparison to their control formulation which did not contain a semi-crystalline propylene-ethylene copolymer.

As seen in comparing the Shore D hardness of Example 11 (Shore D 50.9), the accelerator master batch formulation, comprising a hydrocarbon resin/semi-crystalline propylene-ethylene copolymer carrier, exhibited an increased Shore D hardness of 51.3.

### Examples 31-35: Sulfur Master Batches Formulations with and without Hydrocarbon Resin Made with the Internal Batch Mixing Process

Example 31 was the control sulfur master batch formulation using a commercial product (Vistalon™ 404) based on an EPDM binder. Examples 32 to 35 were sulfur master batch formulations comprising a semi-crystalline propylene-ethylene copolymer. Example 32 was a sulfur master batch formulation comprising a semi-crystalline propylene-ethylene copolymer and sulfur. Examples 33, 34 and 35 were sulfur master batch formulations comprising a semi-crystalline propylene-ethylene copolymer and a hydrocarbon resin as carrier and sulfur.

| | Ex. 31 | Ex. | Ex. | Ex. | Ex. |
|---|---|---|---|---|---|
| Ingredient | (control) | 32 | 33 | 34 | 35 |
| Vistalon ™ 404 (1) | 25 | | | | |
| Vistamaxx ™ 3000 (2) | | 25 | 12.50 | 6.25 | 6.25 |
| Sulfur | 75 | 75 | 75.0 | 75.0 | 75.0 |
| Escorez 5300(3) | | | 12.5 | | 18.75 |
| Escorez 5320(4) | | | | 18.75 | |
| TOTAL (%) | 100 | 100 | 100 | 100 | 100 |
| SHORE D | 6.98 | 42.7 | 50.4 | 51.3 | 58.5 |
| (ASTM 2240) | | | | | |
| Shore D Comparison | | 6. 1× | 7.2× | 7.3× | 8.4× |
| to Control | | | | | |

(1) Ethylene propylene copolymer rubber, 45 wt % ethylene content from ExxonMobil Chemical
(2) Copolymer of Isotactic propylene with random ethylene distribution from ExxonMobil Chemical
(3) & (4)Hydrocarbon resins from ExxonMobil

All Examples 31 to 35 were measured for hardness using the method of ASTM 2240. Examples 32 to 35 comprised a semi-crystalline propylene-ethylene copolymer and sulfur. Sulfur Master Batch Examples 32-35 exhibited increased Shore D hardness (6.1× to 8.4×) in comparison to their control formulation which did not contain a semi-crystalline propylene-ethylene copolymer. Sulfur Master Batch Examples 33 to 35 containing a semi-crystalline propylene-ethylene copolymer and a hydrocarbon resin as a carrier exhibited increased Shore D hardness (Shore D 50.4 to 58.5) over Example 32 (Shore D 42.7) which only contained a semi-crystalline propylene-ethylene copolymer as carrier.

Continuous Twin Screw Mixing Process:

The following master batch formulations were made using a continuous twin screw mixing process as follows: All components were listed in %. The compounds were mixed in suitable twin screw extruders equipped with an underwater pelletizer well known to the person skilled in the art. Typical operating parameters: 200-275 pounds/hour output rate, 50-100 rpm, 50-75% torque, barrel temperature: 60-120 F, die temperature: 200-300F, 8 to 12 holes die plate. Pelletizer water temperature: 60-110 F.

In all cases, the final product obtained was a free-flowing, non-agglomerated, hard pellets with excellent pellet handling stability. The following examples illustrated the improvement in hardness of the master batches produced with a semi-crystalline propylene-ethylene copolymer binder with and without the use of hydrocarbon tackifier resin when compared to commercial product based on an amorphous EPDM binder.

### Examples 36-39: Vulcanization Accelerator Master Batch Formulations with and without Hydrocarbon Resin Made with a Continuous Twin Screw Mixing Process

Example 36 was the control accelerator master batch formulation using a commercial product (Rhenogran TBBS-80 from LANXESS) based on an EPDM binder.

Examples 37 to 39 were accelerator master batch formulations comprising a semi-crystalline propylene-ethylene copolymer. Example 37 was an accelerator master batch formulation comprising a semi-crystalline propylene-ethylene copolymer and an accelerator. Examples 38 and 39 were accelerator master batch formulations comprising a semi-crystalline propylene-ethylene copolymer, an accelerator and a hydrocarbon resin.

| | Ex. 36 | | | |
|---|---|---|---|---|
| Ingredient | (control) | Ex. 37 | Ex. 38 | Ex. 39 |
| EPDM + dispersing agent | 20 | | | |
| (Rhenogran TBBS-80 from | | | | |
| LANXESS) | | | | |
| Vistamaxx ™ 3000 (1) | | 25 | 12.50 | 8.30 |
| TBBS (2) | 80 | 75 | 75.00 | |
| MBTS (3) | | | | 66.70 |
| Sulfur | | | | |
| Escorez 5300 (4) | | | 12.5 | 25 |
| Escorez 5320 (5) | | | | |
| TOTAL (%) | 100 | 100 | 100 | 100 |
| SHORE D (ASTM 2240) | 9.2 | 52.4 | 54.2 | 64.1 |
| Shore D Comparison to Control | | 5.7× | 5.9× | 7.0× |

(1) Copolymer of Isotactic propylene with random ethylene distribution from ExxonMobil Chemical
(2) N-tert-butyl-benzothiazole sulfonamide
(3) Benzothiazole disulfide
(4) & (5) Hydrocarbon resins from ExxonMobil

Examples 36 to 39 were measured for hardness using the method of ASTM 2240. Examples 37 to 39 comprised a semi-crystalline propylene-ethylene copolymer. Vulcanization accelerator master batch Examples 37 to 39 exhibited increased hardness in comparison to their control formulation which did not contain a semi-crystalline propylene-ethylene copolymer.

Vulcanization accelerator Master Batch Examples 38 and 39 containing a semi-crystalline propylene-ethylene copolymer and a hydrocarbon resin as a carrier exhibited an increased Shore D hardness (Shore D 54.2 to 64.1) over Example 37 (Shore D 52.4) which only contained a semi-crystalline propylene-ethylene copolymer as carrier. Accelerator master batch Example 39 also exhibited an increased Shore D hardness (Shore D 64.1) over Example 38 (Shore D 54.2) with an increase in the percentage of hydrocarbon resin in the accelerator master batch.

Vulcanization accelerator Master Batch Example 39 comprising semi-crystalline propylene-ethylene copolymer and a hydrocarbon resin as a carrier and benzothiazole disulfide (MBTS) as vulcanization accelerator exhibited the greatest Shore D hardness (Shore D 64.1) in comparison to its control formulation comprising amorphous propylene-ethylene copolymer as carrier (Shore D 9.2).

A comparison of accelerator master batch Example 11 made with the internal batch mixing process (Shore D 50.9) and accelerator master batch Example 37 made with the continuous twin screw mixing process (Shore D 52.4) indicated that both processes produced similar Shore D hardness results with the continuous twin screw mixing process producing increased Shore D hardness product.

### Examples 40-44: Sulfur Master Batch Formulations with and without Hydrocarbon Resin Made with a Continuous Twin Screw Mixing Process

Examples 40 to 44 were sulfur master batch formulations comprising a semi-crystalline propylene-ethylene copolymer. Examples 40 and 41 were sulfur master batch formulations comprising a semi-crystalline propylene-ethylene copolymer, sulfur and an accelerator. Examples 42 and 43 were sulfur master batch formulations comprising a semi-crystalline propylene-ethylene copolymer, sulfur and a hydrocarbon resin. Example 44 was a sulfur master batch formulation comprising a semi-crystalline propylene-ethylene copolymer, sulfur, an accelerator and a hydrocarbon resin.

| Ingredient | Ex. 40 | Ex. 41 | Ex. 42 | Ex. 43 | Ex. 44 |
|---|---|---|---|---|---|
| Vistamaxx ™ 3000 (1) | 25 | 25 | 20 | 8.30 | 12.50 |
| TBBS (2) | 17.3 | 28.1 | | | |
| MBTS (3) | | | | | 22.20 |
| Sulfur | 57.7 | 46.9 | 60 | 66.7 | 52.8 |
| Escorez 5300 (4) | | | 20 | 25 | 12.5 |
| Escorez 5320 (5) | | | | | |
| TOTAL (%) | 100 | 100 | 100 | 100 | 100 |
| Ingredient | Ex. 40 | Ex. 41 | Ex. 42 | Ex. 43 | Ex. 44 |
| SHORE D (ASTM 2240) | 47.2 | 48.5 | 41.4 | 61.9 | 51.2 |

(1) Copolymer of Isotactic propylene with random ethylene distribution from ExxonMobil Chemical
(2) N-tert-butyl-benzothiazole sulfonamide
(3) Benzothiazole disulfide
(4) & (5) Hydrocarbon tackifier resins from ExxonMobil

Examples 40 to 44 were measured for hardness using the method of ASTM 2240. Examples 40 to 44 comprised a semi-crystalline propylene-ethylene copolymer. Sulfur master batch Example 43 exhibited increased Shore D hardness (Shore D 61.9) over Example 44 (Shore D 51.2) with an increase in the percentage of hydrocarbon resin in the sulfur master batch formulation.

### Examples 45-47: Carbon Master Batch Formulations

Example 45 was the control carbon master batch formulation using amorphous EPDM and hydrocarbon resin as the carrier, carbon black and an antioxidant made with an internal batch mixing process. Examples 46 and 47 were carbon master batch formulations comprising a semi-crystalline propylene-ethylene copolymer and a hydrocarbon resin as the carrier, carbon black and an antioxidant made with a continuous twin screw mixing process

| | Ex. 45 | Ex. 46 | Ex. 47 |
|---|---|---|---|
| Ingredient | (control) (6) | (7) | (7) |
| Vistaion ™ 404 (1) | 26 | | |
| Vistamaxx ™ 3000 (2) | | 28.10 | 26 |
| N330 CB (3) | 40 | 38.00 | 40 |
| Chimassorb 2020 (4) | 8 | 15.2 | 8 |
| Escorez 5320 (5) | 26 | 18.7 | 26 |
| TOTAL (%) | 100 | 100 | 100 |
| SHORE D (ASTM 2240) | 17.1 | 58.2 | 62.4 |
| Shore D Comparison to Control | | 3.4× | 3.6× |

(1) Ethylene propylene copolymer rubber, 45 wt % ethylene content from ExxonMobil Chemical
(2) Copolymer of Isotactic propylene with random ethylene distribution from ExxonMobil Chemical
(3) Carbon black Vulcan ® 3 N330 from Cabot Corp.
(4) High-molecular-weight, hindered amine light stabilizer from BASF Corp.
(5) Hydrocarbon resin from ExxonMobil
(6) Made with internal batch mixing process
(7) Made with continuous twin screw mixing process

Examples 45 to 47 were measured for hardness using the method of ASTM 2240. Examples 46 and 47 comprised a semi-crystalline propylene-ethylene copolymer and a hydrocarbon resin as a carrier. Carbon master batch Examples 46 and 47 exhibited increased hardness (3.4× to 3.6×) in comparison to their control formulation which did not contain a semi-crystalline propylene-ethylene copolymer.

Further, carbon black master batch Example 49 exhibited increased Shore D hardness (Shore D 62.4) over Example 46 (Shore D 58.2) with an increase in the percentage of hydrocarbon resin in the carbon black master batch formulation.

In the specification and in the claims, the terms “including” and “comprising” are open-ended terms and should be interpreted to mean “including, but not limited to”. These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

What is claimed is:

1. A sulfur curative master batch composition comprising:
about 10 to about 30 percent semi-crystalline propylene-olefin copolymer;
about 45 to about 60 percent sulfur;
and about 10 to about 40 percent vulcanizing accelerator.

2. The sulfur curative master batch composition of claim 1, wherein the semi-crystalline propylene-olefin copolymer is an ethylene-propylene copolymer.

3. The sulfur curative master batch composition of claim 1, wherein the semi-crystalline propylene-olefin copolymer is a combination of a semi-crystalline propylene-olefin copolymer and amorphous propylene-olefin copolymer.

4. The sulfur curative master batch composition of claim 1, further comprising a cure retarder.

5. The sulfur curative master batch composition of claim 1, further comprising about 10 to about 20 percent hydrocarbon resin.

6. The sulfur curative master batch composition of claim 1, further comprising about 1 to about 30 percent antioxidant.

7. The sulfur curative master batch composition of claim 6 comprising about 1 to about 10 percent antioxidant.

8. The sulfur curative master batch composition of claim 1, wherein the vulcanizing accelerator is selected from the group consisting of N-tert-butyl-2-benzothiazole sulphenamide and 2,2′-dithiobisbenzothiazole.

9. The sulfur curative master batch composition of claim 1, wherein the Shore D hardness is from about 30 to about 70.

10. The sulfur curative master batch composition of claim 9, wherein the Shore D hardness is from about 40 to about 60.

11. A sulfur curative master batch composition comprising:
about 5 to about 30 percent semi-crystalline propylene-olefin copolymer;
about 10 to about 20 percent hydrocarbon resin and about 60 to about 80 percent sulfur.

12. The sulfur curative master batch composition of claim 11, wherein the semi-crystalline propylene-olefin copolymer is an ethylene-propylene copolymer.

13. The sulfur curative master batch composition of claim 11, wherein the semi-crystalline propylene-olefin copolymer is a combination of a semi-crystalline propylene-olefin copolymer and amorphous propylene-olefin copolymer.

14. The sulfur curative master batch composition of claim 11, further comprising about 1 to about 30 percent antioxidant.

15. The sulfur curative master batch composition of claim 11, wherein the Shore D hardness is from about 30 to about 70.

16. The sulfur curative master batch composition of claim 15, wherein the Shore D hardness is from about 40 to about 60.

17. A sulfur curative master batch composition comprising:
about 5 to about 30 percent semi-crystalline propylene-olefin copolymer;
about 10 to about 30 percent hydrocarbon resin
about 50 to about 80 percent sulfur;
and about 10 to about 80 percent vulcanizing accelerator.

18. The sulfur curative master batch composition of claim 17, wherein the semi-crystalline propylene-olefin copolymer is an ethylene-propylene copolymer.

19. The sulfur curative master batch composition of claim 17, wherein the semi-crystalline propylene-olefin copolymer is a combination of a semi-crystalline propylene-olefin copolymer and amorphous propylene-olefin copolymer.

20. The sulfur curative master batch composition of claim 17, further comprising about 1 to about 30 percent antioxidant.

21. The sulfur curative master batch composition of claim 17, wherein the Shore D hardness is from about 30 to 70.

22. The sulfur curative master batch composition of claim 21, wherein the Shore D hardness is from about 40 to 70.

23. The sulfur curative master batch composition of claim 5, wherein the ratio of semi-crystalline propylene-olefin copolymer to hydrocarbon resin in the sulfur curative master batch ranges from about 1:1 to about 1:4 semi-crystalline propylene-olefin copolymer: hydrocarbon resin.

24. The sulfur curative master batch composition of claim 23, wherein the ratio of semi-crystalline propylene-olefin copolymer to hydrocarbon resin ranges from about 1:1 to about 1:3 semi-crystalline propylene-olefin copolymer: hydrocarbon resin.

25-48. (canceled)
